(19) United States
(12) Patent Application Publication
(10) Pub. No.: US 2026/0357623 A1
(43) Pub. Date: Nov. 12, 2026

(54) DOOR HANDLE DEVICE FOR VEHICLE

(71) Applicants: ALPHA CORPORATION, Kanagawa (JP); NISSAN JIDOSHA KABUSHIKI KAISHA (ALSO TRADING AS NISSAN MOTOR CO., LTD.), Kanagawa (JP)

(72) Inventors: Tomoaki KUZUOKA, Kanagawa (JP); Satoshi KUBOTA, Kanagawa (JP); Maharu TSUNASHIMA, Kanagawa (JP); Kouji TSUJI, Kanagawa (JP)

(73) Assignees: ALPHA CORPORATION, Kanagawa (JP); NISSAN JIDOSHA KABUSHIKI KAISHA (ALSO TRADING AS NISSAN MOTOR CO., LTD.), Kanagawa (JP)

(21) Appl. No.: 19/670,634

(22) Filed: May 7, 2026

(30) Foreign Application Priority Data
May 8, 2025 (JP) 2025-078245
Apr. 7, 2026 (JP) 2026-063271

(51) Int. Cl. E05B 85/16

(52) U.S. Cl. CPC E05B 85/16

(57) ABSTRACT

A door handle device for a vehicle, the door handle device includes: a base member provided on a back surface of a door panel of a vehicle; and a handle member provided on the base member from a front surface side of the door panel. The base member includes a base member opening edge that defines a base member opening communicating with an opening of the door panel. The handle member includes a main body portion formed in an elongated shape and exposed on a front surface of the door panel, and a hinge arm portion protruding from one end side of the main body portion in a longitudinal direction. The hinge arm portion includes an elongated movement restricting portion restricting a movement range of the handle member by abutting against the base member opening edge when the hinge arm portion is inserted into the base member opening.

### CROSS-REFERENCE TO RELATED APPLICATIONS

This application is based on and claims priority under 35 USC 119 from Japanese Patent Application No. 2025-078245 filed on May 8, 2025 and No. 2026-063271 filed on Apr. 7, 2026, the entire content of which is incorporated herein by reference.

### TECHNICAL FIELD

The present disclosure relates to a door handle device for a vehicle.

### BACKGROUND ART

As a door handle device for a vehicle, for example, as described in JP2006-063575A, a door handle device for a vehicle that includes a base member fixed to a back surface of a door panel and a grip member tiltably supported on the base member and provided from a surface of the door panel is known. The grip member includes a support arm having a bearing hole on one end side. The support arm is inserted into an arm housing portion from the opening of the base member, and a bearing hole of the support arm is engaged with a tilting shaft formed in the arm housing portion. Accordingly, the grip member is prevented from rattling while being tiltable.

### SUMMARY OF INVENTION

Here, as in the door handle device for a vehicle described in JP2006-063575A, since the grip member (the handle member) is incorporated into the base member fixed to the back side of the door panel, when the support arm (the hinge arm portion) is inserted into the frame opening of the base member, a part of the grip member may come into contact with the door panel, and the door panel may be damaged.

The present disclosure has been made in view of the above problems, and an object of the present disclosure is to provide a door handle device for a vehicle capable of preventing a handle member from coming into contact with a door panel when a part of the handle member is inserted into an opening of a base member in order to incorporate the handle member into a vehicle door, and improving ease of incorporation.

A door handle device for a vehicle, the door handle device includes: a base member provided on a back surface of a door panel of a vehicle; and a handle member provided on the base member from a front surface side of the door panel. The base member includes a base member opening edge that defines a base member opening communicating with an opening of the door panel. The handle member includes: a main body portion formed in an elongated shape and exposed on a front surface of the door panel; and hinge arm portion protruding from one end side of the main body portion in a longitudinal direction, penetrating the opening of the door panel and the base member opening, and rotatably supported on a support portion of the base member. The hinge arm portion includes an elongated movement restricting portion configured to restrict a movement range of the handle member by abutting against the base member opening edge when the hinge arm portion is inserted into the base member opening.

According to the present disclosure, it is possible to provide a door handle device for a vehicle capable of preventing a handle member from coming into contact with a door panel when a part of the handle member is inserted into an opening of a base member in order to incorporate the handle member into a vehicle door, and improving ease of incorporation.

### BRIEF DESCRIPTION OF DRAWINGS

FIG. 1 is a front view of a door handle device for a vehicle according to an embodiment of the present disclosure;

FIG. 2 is a cross-sectional view taken along a line II-II in FIG. 1;

FIG. 3 is a view showing an operation state of the door handle device for a vehicle;

FIG. 4A is a perspective view showing a hinge arm portion of a handle member;

FIG. 4B is a plan view of the hinge arm portion of the handle member as viewed from a vehicle inner side;

FIG. 5A is a plan view of a base member opening as viewed from a vehicle outer side; FIG. 5B is a cross-sectional view taken along a line V-V in FIG. 5A; FIG. 5C is a perspective view of the base member opening;

FIG. 6 is a cross-sectional view showing a state in which the handle member is incorporated into a base member;

FIG. 7 is a cross-sectional view showing a state in which the handle member is incorporated into the base member;

FIG. 8 is a cross-sectional view showing a state in which the handle member is incorporated into the base member;

FIG. 9A is a cross-sectional view showing a modification of the handle member;

FIG. 9B is a cross-sectional view showing a modification of the handle member; FIG. 9C is a cross-sectional view showing a modification of the handle member; FIG. 9D is a cross-sectional view showing a modification of the handle member;

FIG. 10A shows a modification of the base member; and FIG. 10B is a cross-sectional view showing a modification of the handle member and the base member at a position indicated by a line X-X in FIG. 10A.

FIG. 11A is a plan view of a gasket according to another embodiment as viewed from a vehicle outer side; FIG. 11B is a plan view of the gasket according to another embodiment as viewed in a direction of arrow XI in FIG. 11A; FIG. 11C is a plan view of the gasket according to another embodiment as viewed in a direction of arrow XI′ in FIG. 11A.

FIG. 12 is a plan view of the gasket provided on the door panel as viewed from a vehicle outer side.

FIG. 13 is a cross-sectional view showing an aspect in which the handle member is incorporated into the base member, and corresponds to a position indicated by a line XIII-XIII in FIG. 12.

### DESCRIPTION OF EMBODIMENTS

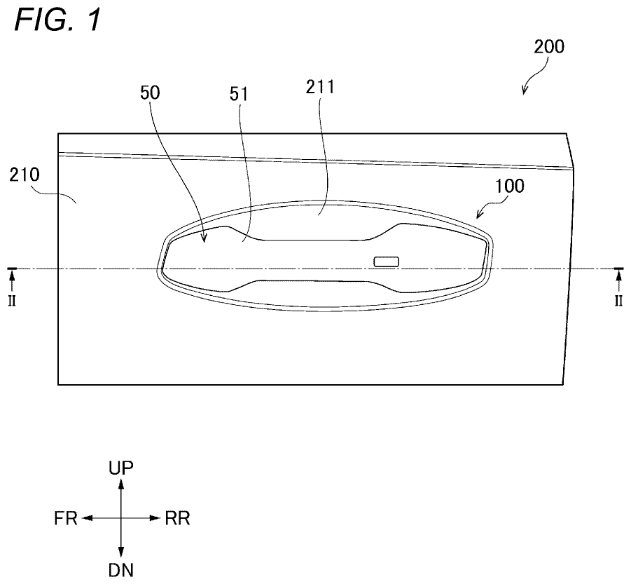

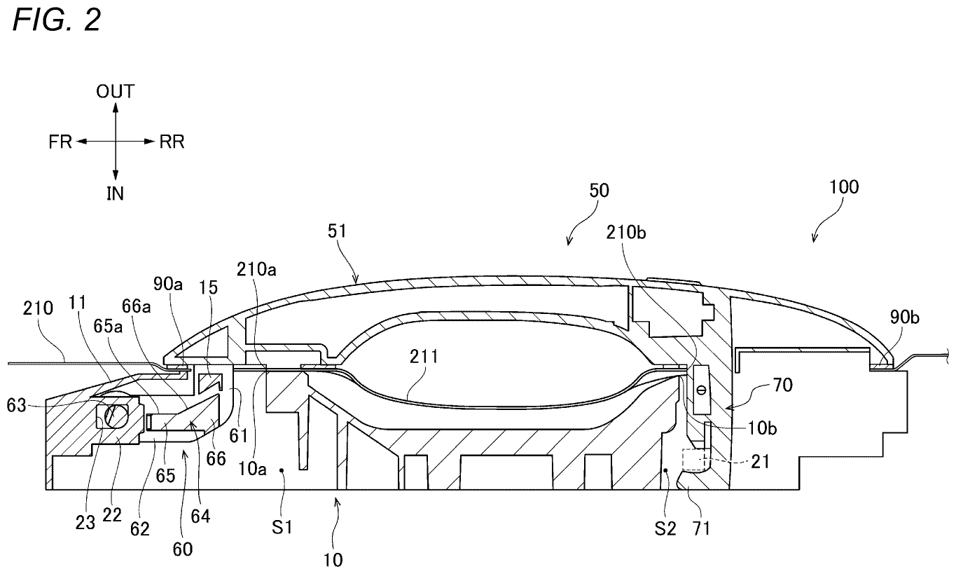

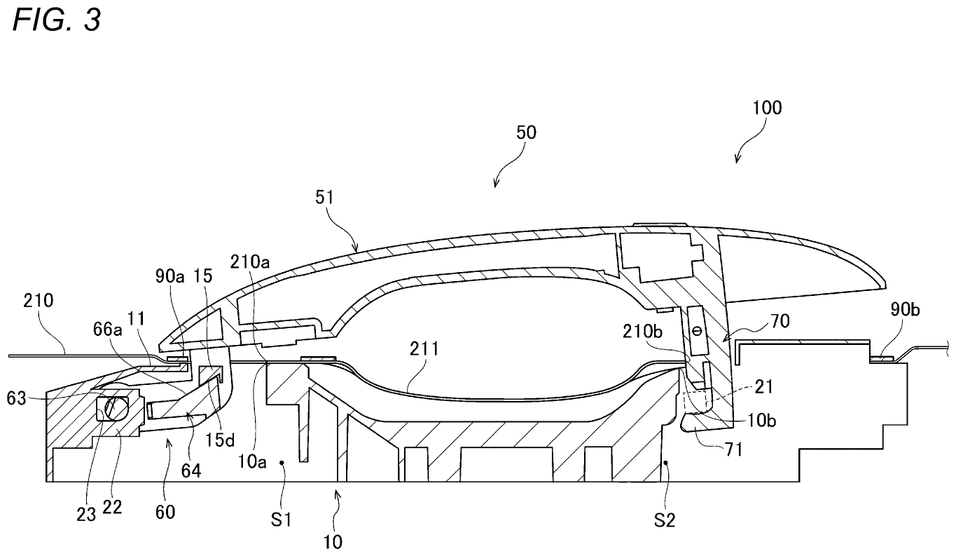

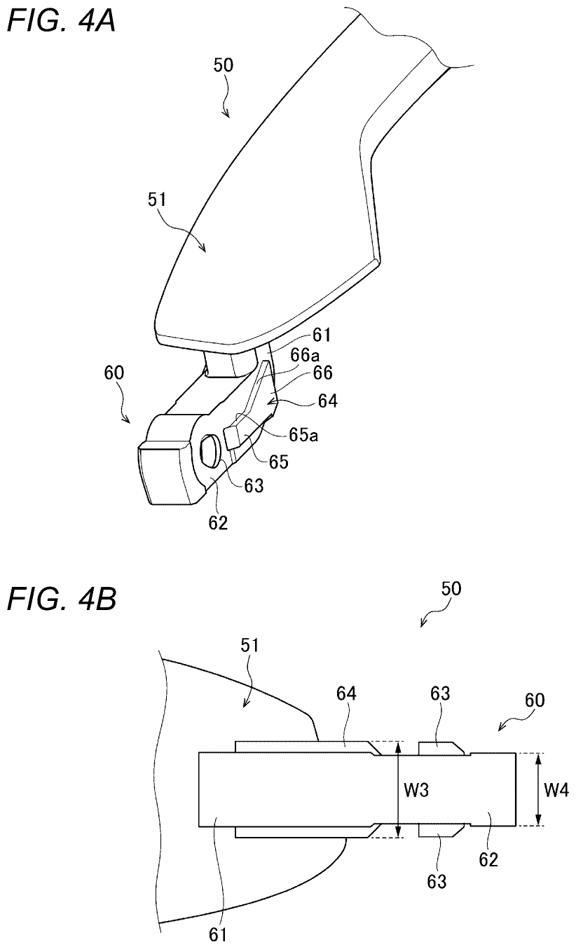

Hereinafter, an embodiment of the present disclosure will be described with reference to the accompanying drawings. FIG. 1 is a front view of a door handle device for a vehicle according to an embodiment of the present disclosure. FIG. 2 is a cross-sectional view taken along a line II-II in FIG. 1. FIG. 3 is a view showing an operation state of the door handle device for a vehicle. FIG. 4A is a perspective view showing a hinge arm portion of a handle member. FIG. 4B is a plan view of the hinge arm portion of the handle member as viewed from a vehicle inner side.

As shown in FIGS. 1 and 2, a door handle device 100 for a vehicle is attached to a vehicle door 200 and is used for performing a door opening and closing operation. Hereinafter, the door handle device 100 for a vehicle is simply referred to as a door handle device 100. The door handle device 100 includes a base member 10 provided on the back surface of a door panel 210 forming the outer shape of the vehicle door 200, and a handle member 50 provided from the front surface side of the door panel 210 and formed in an elongated shape. The base member 10 is fastened to the door panel 210 by bolts or the like, and the handle member 50 is connected to the base member 10 rotatably in a predetermined range with the door panel 210 interposed between the handle member 50 and the base member 10.

Hereinafter, a state will be described in which the door handle device 100 is attached to the vehicle door 200. At this time, the vehicle height direction is referred to as an upper-lower direction, UP in FIG. 1 indicates the upper side in the upper-lower direction, and DN indicates the lower side of the vehicle in the upper-lower direction. A direction away from the door panel 210 is referred to as a vehicle width direction, a direction in which the door handle device 100 and the base member 10 formed in an elongated shape extend is referred to as a front-rear direction, FR in FIGS. 1 and 2 indicates the front side in the front-rear direction, and RR indicates the rear side in the front-rear direction. OUT in FIG. 2 indicates a direction (hereinafter, referred to as a vehicle outer side) from the inside to the outside of the vehicle in the vehicle width direction, and IN indicates a direction (hereinafter, referred to as a vehicle inner side) from the outside to the inside of the vehicle in the vehicle width direction. The rotation axis direction of the handle member 50 (a hinge arm portion 60) when the handle member 50 is operated from this state coincides with the upper-lower direction.

The door panel 210 includes a curved portion 211 that is curved toward the vehicle inner side so as to increase the distance from the handle member 50. A panel opening 210a penetrating the door panel 210 is formed in front of the curved portion 211, and a panel opening 210b penetrating the door panel 210 is formed behind the curved portion 211.

In particular, as shown in FIG. 2, the base member 10 is a box-shaped member made of resin, and has a hollow first internal space S1 formed in the front side and a hollow second internal space S2 formed in the rear side. An outer wall 11 extending to define one surface of the base member 10 on the vehicle outer side is formed along the shape of the door panel 210. A base member opening 10a that communicates with the panel opening 210a to communicate the outside of the vehicle with the first internal space S1 is formed in front of the outer wall 11. A base member opening 10b that communicates with the panel opening 210b to communicate the outside of the vehicle with the second internal space S2 is formed behind the outer wall 11. The hinge arm portion 60 of the handle member 50 to be described later is inserted into the first internal space S1 via the panel opening 210a and the base member opening 10a, and a guide arm portion 70 to be described later is inserted into the second internal space S2 via the panel opening 210b and the base member opening 10b.

In the first internal space S1, for example, a pair of cantilever-shaped elastic blade pieces 22 elastically deformable in the upper-lower direction are formed on the front wall surface of the base member 10. The pair of elastic blade pieces 22 are support portions for rotatably supporting the handle member 50. The pair of elastic blade pieces 22 include engaged portions 23 that are open in the upper-lower direction and that engage with support protrusions 63 formed on the hinge arm portion 60 to be described later.

As shown in FIGS. 1 to 3, the handle member 50 is made of, for example, resin, is formed in an elongated shape, and includes a main body portion 51 exposed on the surface of the door panel 210, the hinge arm portion 60 formed on one end side (the front side) of the main body portion 51 in the longitudinal direction, and the guide arm portion 70 formed on the other end side (the rear side) of the main body portion 51 in the longitudinal direction.

The guide arm portion 70 extends from the main body portion 51 in a direction substantially perpendicular to the longitudinal direction of the handle member 50. A locked step portion 71 protruding forward is formed on the free end side of the guide arm portion 70. The locked step portion 71 is locked to a locking lever 21 provided on the base member 10. The locking lever 21 is driven according to the rotation operation of the handle member 50, and releases the latch maintaining the closed state via a transmission member such as a cable device (not illustrated).

Gaskets 90a and 90b formed in an annular shape along the opening edges of the panel openings 210a and 210b are provided on the vehicle outer side of the door panel 210. The gaskets 90a and 90b are made of, for example, a synthetic resin such as polypropylene or a material having appropriate elasticity such as synthetic rubber, and have substantially the same outer shape as a contact surface of the main body portion 51 of the handle member 50 with the door panel 210. The gaskets 90a and 90b are provided between the main body portion 51 of the handle member 50 and the door panel 210 to have a buffer function, a water immersion prevention function, and a protection function of preventing the handle member 50 and the door panel 210 from being damaged.

The hinge arm portion 60 includes a base portion 61 protruding from the main body portion 51 in a direction substantially parallel to the guide arm portion 70, and a hinge portion 62 protruding forward from an end portion of the base portion 61 opposite to the main body portion 51, and is formed in a substantially L shape when viewed from the upper-lower direction. On the front end side of the hinge portion 62, a pair of support protrusions 63 protruding on two sides in the upper-lower direction are formed. When the engaged portion 23 of the base member 10 is engaged with the support protrusion 63, the hinge arm portion 60 is rotatably supported on the base member 10. Accordingly, when the handle member 50 is operated, the handle member 50 rotates on a plane perpendicular to the upper-lower direction with the support protrusion 63 as a rotation axis. The shape of the engagement portion (the support protrusion 63 and the engaged portion 23) between the handle member 50 and the base member 10 is not limited to the shape described above. For example, the elastic blade piece 22 may be provided with a support protrusion, and the hinge arm portion 60 may be formed with an engaged portion that engages with the support protrusion of the elastic blade piece 22.

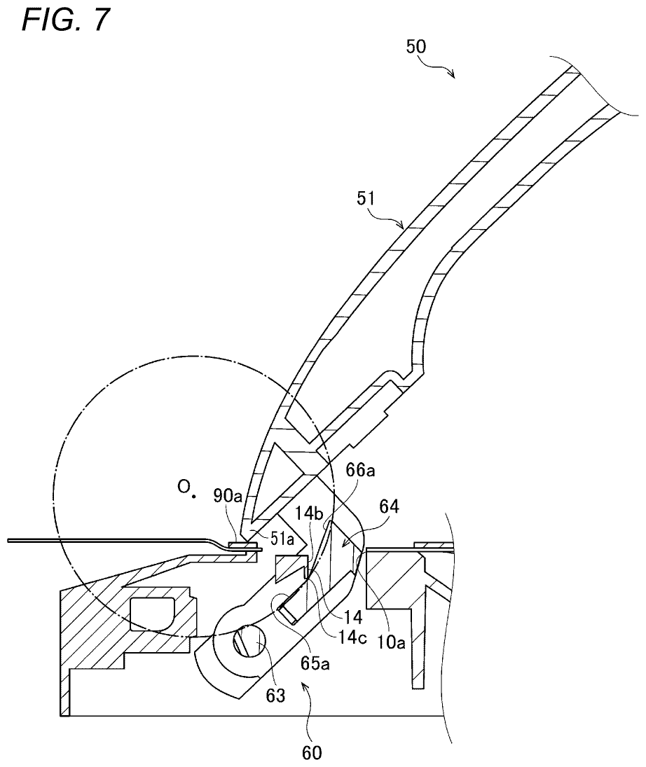

The hinge arm portion 60 includes an elongated restricting protrusion 64 (a movement restricting portion) that protrudes from two end surfaces of the hinge arm portion 60 in the upper-lower direction (the rotation axis direction) on the rear side with respect to the support protrusion 63 and that extends in the longitudinal direction of the hinge arm portion 60. The restricting protrusion 64 extends across the hinge portion 62 and the base portion 61, and can abut against the peripheral edge (the base member opening edge) of the base member opening 10a to be described later. In the present embodiment, the restricting protrusion 64 includes a position restricting portion 65 extending in the longitudinal direction of the handle member 50, and an angle restricting portion 66 formed on the base portion 61 side of the hinge arm portion 60 with respect to the position restricting portion 65 and extending in a direction intersecting the longitudinal direction of the hinge arm portion 60. Here, as illustrated in FIG. 7, when the hinge arm portion 60 is inserted into the base member opening 10a, the hinge arm portion 60 is inserted along a trajectory substantially along the circumference of an imaginary circle indicated by a broken line centered on a point O located on the vehicle outer side of the door panel 210 and in front of the base member opening 10a. The angle restricting portion 66 extends with respect to the position restricting portion 65 in a direction along the circumference of the imaginary circle centered on the point O, that is, in the rotation direction of the hinge arm portion 60 at the time of insertion.

As shown in FIGS. 2, 4A, and 4B, a position restricting surface 65a extending in the longitudinal direction of the handle member 50 and facing the vehicle outer side is formed at the vehicle outer side end portion of the position restricting portion 65. An angle restricting surface 66a obliquely connected to the position restricting surface 65a is formed at the vehicle outer side end portion of the angle restricting portion 66. The angle restricting surface 66a is inclined in a direction approaching the main body portion 51 of the handle member 50 toward the rear side. In the illustrated example, the position restricting surface 65a and the angle restricting surface 66a are connected so as to be bent at the boundary portion.

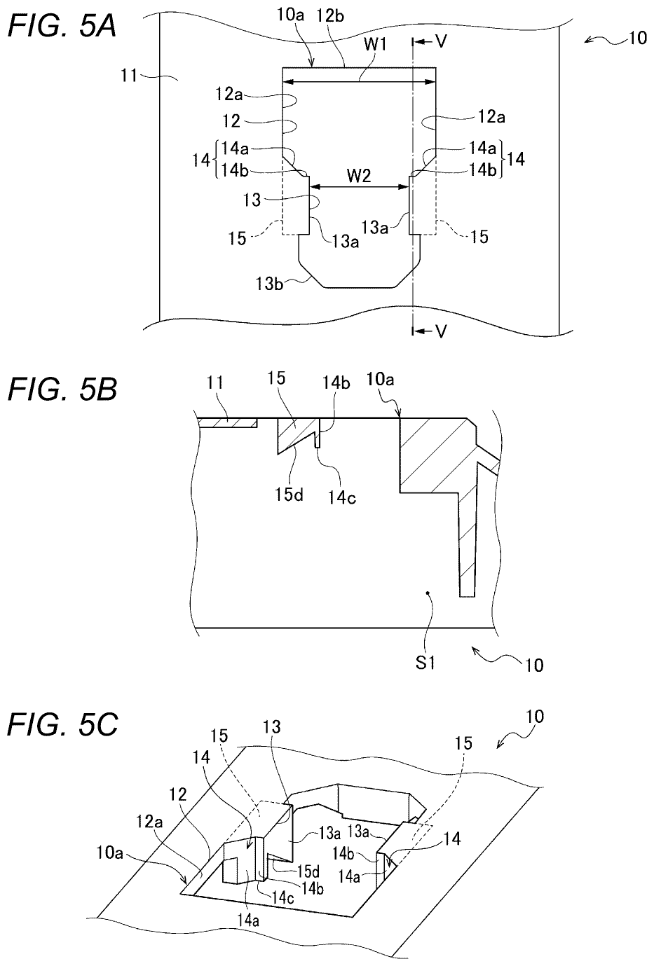

FIG. 5A is a plan view of the base member opening as viewed from the vehicle outer side. FIG. 5B is a cross-sectional view taken along a line V-V in FIG. 5A. FIG. 5C is a perspective view of the base member opening. The lower side in FIG. 5A is the front of the vehicle, and the upper side in FIG. 5A is the rear of the vehicle. The front-rear direction also coincides with the longitudinal direction of the base member. As shown in FIGS. 5A to 5C, the base member opening 10a includes a widened portion 12 formed closer to the rear side of the base member opening 10a when viewed from the vehicle outer side, and a narrowed portion 13 formed in front of the widened portion 12. An upper-lower direction width W1 of the widened portion 12 is larger than an upper-lower direction width W2 of the narrowed portion 13, an upper-lower direction width W3 (see FIG. 4B) of the restricting protrusion 64 (the position restricting portion 65 and the angle restricting portion 66) formed on the hinge arm portion 60, and an upper-lower direction width of the pair of support protrusions 63. The upper-lower direction width W2 of the narrowed portion 13 is smaller than the upper-lower direction width W1 of the widened portion 12 and the upper-lower direction width W3 of the restricting protrusion 64. The upper-lower direction width W2 of the narrowed portion 13 is larger than the upper-lower direction width W4 (see FIG. 4B) of the portion of the hinge arm portion 60 where the support protrusion 63 and the restricting protrusion 64 are not formed.

The base member opening edge that is the peripheral edge of the base member opening 10a includes a pair of upper and lower edge portions 12a that each define a respective one of the end portions of the widened portion 12 in the upper-lower direction, an edge portion 12b that connects the pair of edge portions 12a, a pair of upper and lower edge portions 13a that each define a respective one of the end portions of the narrowed portion 13 in the upper-lower direction, an edge portion 13b that connects the pair of edge portions 13a, and a pair of upper and lower step portions 14 that connect the edge portions 12a and the edge portions 13a. The step portion 14 includes an edge portion 14a and an edge portion 14b. The edge portion 14a is an inclined surface connected so as to be inclined with respect to the edge portion 12a of the widened portion 12. The edge portion 14b is a plane connected perpendicularly to the edge portion 13a of the narrowed portion 13. The base member opening edge has a constant thickness in the vehicle width direction as a whole. The edge portions 14a and 14b further extend from the base member opening edge in the vehicle width direction and form a part of a bulging portion 15 to be described later.

In the present embodiment, the outer wall 11 includes a pair of bulging portions 15 that are provided on two sides of the narrowed portion 13 in the upper-lower direction so as to bulge thick on the vehicle inner side so as to constitute a part of the base member opening edge that is the peripheral edge of the base member opening 10a. The pair of bulging portions 15 constitute an edge portion 13a that is an end portion of the narrowed portion 13 in the upper-lower direction by an end surface facing the narrowed portion 13. That is, the gap between the facing end surfaces of the pair of bulging portions 15 is the upper-lower direction width W2 of the narrowed portion. The rear end portions of the bulging portions 15 constitute the edge portions 14a and 14b.

The base member opening edge and the hinge arm portion 60 have the dimensional relationship described above. Accordingly, when the hinge arm portion 60 is inserted into the base member opening edge, the support protrusion 63 and the restricting protrusion 64 can be inserted into the widened portion 12, but cannot be inserted into the narrowed portion 13. When the hinge arm portion 60 moves from the state of being inserted into the widened portion 12 to the narrowed portion 13 side, the restricting protrusion 64 of the hinge arm portion 60 abuts against the edge portion 14a or the edge portion 14b of the step portion 14, and thus the hinge arm portion 60 cannot move to the narrowed portion 13 side. On the other hand, a portion of the hinge arm portion 60 where the support protrusion 63 and the restricting protrusion 64 are not formed does not abut against the edge portion 14a and the edge portion 14b, and thus can move from the widened portion 12 to the narrowed portion 13. As described above, the restricting protrusion 64 abuts against the edge portions 14a and 14b, so that the position and the angle of the handle member 50 when the hinge arm portion 60 is inserted can be restricted. A part of the hinge arm portion 60 can be inserted into the narrowed portion 13, so that the ease of incorporation is also favorably maintained.

The bulging portion 15 is formed on the vehicle inner side and has an inclined surface 15d inclined in a direction toward the vehicle outer side from the front side to the rear side. As shown in FIG. 3, when the handle member 50 is rotated, the rear end portion of the angle restricting surface 66a of the handle member 50 and the inclined surface 15d abut against each other, thereby preventing the handle member 50 from being excessively rotated. As described above, in the present embodiment, the bulging portion 15 restricts the position and the insertion angle of the handle member 50 when the handle member 50 is incorporated into the base member 10, and also restricts the operation range of the handle member 50 after the incorporation, thereby preventing damage to the door panel 210 during and after the incorporation. At this time, it is desirable that the restricting protrusion 64 of the hinge arm portion 60 has a large width in the vehicle width direction to the extent that the strength capable of restricting the movement and rotation of the handle member 50 is secured.

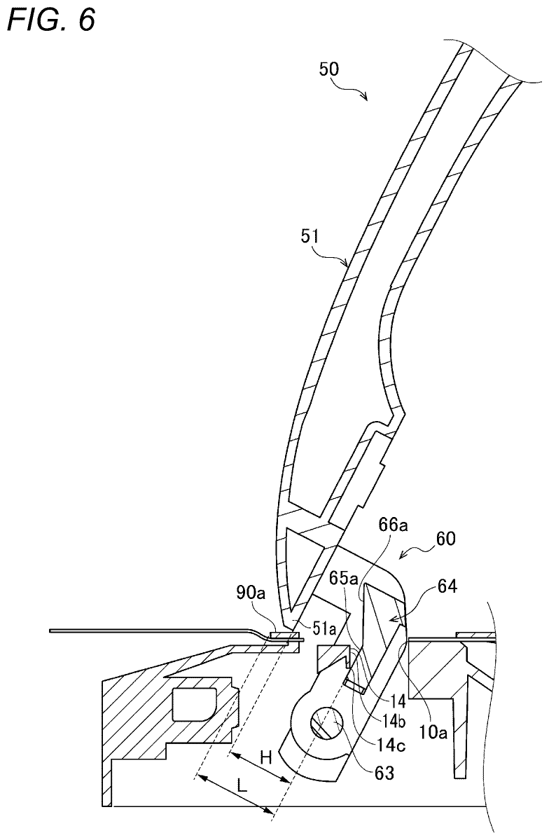

Hereinafter, an aspect in which the handle member 50 is incorporated into the base member 10 will be described with reference to FIGS. 6 to 8. As shown in FIG. 6, in the handle member 50, the hinge arm portion 60 is inserted into the base member opening 10a in a state in which the longitudinal direction of the handle member 50 is parallel to the vehicle width direction or in a state in which the other end side in the longitudinal direction is slightly inclined rearward. At this time, the support protrusion 63 and the restricting protrusion 64 of the hinge arm portion 60 cannot be inserted into the narrowed portion 13 having a small upper-lower direction width, and can be inserted into only the widened portion 12 having a large upper-lower direction width. Therefore, when the hinge arm portion 60 is inserted into the base member opening 10a, the insertion position of the base member 10 in the longitudinal direction is restricted.

Even when the operator pushes the handle member 50 forward from a state in which the hinge arm portion 60 is inserted into the widened portion 12, the position restricting surface 65a of the hinge arm portion 60 abuts against the step portion 14 in the base member 10, so that the forward movement of the handle member 50 is restricted. At this time, a distance in the direction in which the base portion 61 extends between the contact point between the step portion 14 and the restricting protrusion 64 and the contact surface of the main body portion 51 of the handle member 50 with the door panel is defined as H. A distance between the contact point between the step portion 14 and the restricting protrusion 64 and the front end portion of the gasket 90a in the direction in which the base portion 61 extends is defined as L. Since the distance H is set to be shorter than the distance L when the position restricting surface 65a abuts against the step portion 14, a distal end portion 51a on one end side of the main body portion 51 of the handle member 50 in the longitudinal direction advances beyond the front end portion of the gasket 90a, and the handle member 50 and the door panel 210 are prevented from coming into contact with each other.

As shown in FIG. 7, when the hinge arm portion 60 is inserted deeper into the first internal space S1 than in the state in FIG. 6, the angle restricting surface 66a abuts against the edge portion 14a, the edge portion 14b, or a vehicle inner side end portion 14c of the edge portion 14b. At this time, since the position restricting surface 65a and the angle restricting surface 66a are connected so as to be bent at the boundary portion, the operator can obtain a click feeling. Since the angle restricting surface 66a is inclined with respect to the longitudinal direction (the insertion direction) of the handle member 50, the movement of the handle member 50 in the longitudinal direction (the insertion direction) of the handle member 50 is restricted. When the handle member 50 is further inserted, the other end side of the handle member 50 needs to be rotated so as to be largely inclined rearward, that is, the insertion angle of the handle member 50 is restricted. At this time, the handle member 50 is inserted along the trajectory substantially along the circumference of the virtual circle centered on the point O as described above.

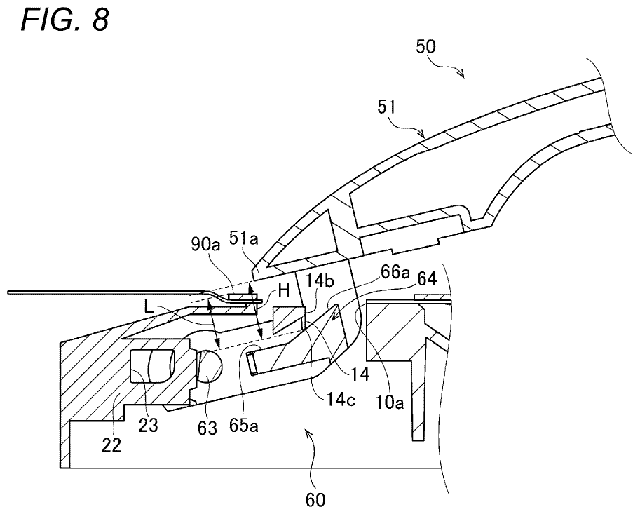

As shown in FIG. 8, by changing the angle of the handle member 50 such that the other end side of the handle member 50 in the longitudinal direction is largely inclined rearward, the hinge arm portion 60 can be inserted further deep into the first internal space S1. At this time, the distance L between the contact point between the step portion 14 and the restricting protrusion 64 and the front end portion of the gasket 90a gradually decreases in proportion to the inclination angle of the handle member 50. However, since the contact point between the step portion 14 and the restricting protrusion 64 moves along the angle restricting surface 66a in a direction approaching the main body portion 51 of the handle member 50, the distance H between the contact point between the step portion 14 and the restricting protrusion 64 and the contact surface of the main body portion 51 of the handle member 50 with the door panel also gradually decreases in proportion to the insertion amount of the hinge arm portion 60. As a result, in a state in which the handle member 50 is inserted deep into the base member 10, the distance H between the contact point between the step portion 14 and the restricting protrusion 64 and the contact surface of the main body portion 51 of the handle member 50 with the door panel is shorter than the distance L between the contact point between the step portion 14 and the restricting protrusion 64 and the front end portion of the gasket 90a. Therefore, even in a state in which the handle member 50 is inserted deep into the base member 10, it is possible to prevent the distal end portion 51a on the one end side of the main body portion 51 in the longitudinal direction from coming into contact with the door panel 210 beyond the front end portion of the gasket 90a. As in the illustrated example, since the bulging portion 15 has a thickness in the vehicle width direction, the strength is secured, the abutting position between the angle restricting surface 66a and the step portion 14 (the vehicle inner side end portion 14c) is on the vehicle inner side, and the angle of the handle member 50 is easily restricted.

Finally, the handle member 50 is inclined until the longitudinal direction thereof substantially coincides with the front-rear direction of the vehicle, and the support protrusion 63 and the engaged portion 23 are engaged with each other while the pair of elastic blade pieces 22 are elastically deformed by the forward sliding movement (see FIG. 2).

As described above, in the door handle device 100 according to the present embodiment, since the handle member 50 is incorporated into the base member 10, when the hinge arm portion 60 is inserted into the base member opening 10a, the position restricting surface 65a and the angle restricting surface 66a that are formed on the restricting protrusion 64 of the hinge arm portion 60 abuts against the base member opening edge (the step portion 14) defining the base member opening 10a, so that the movement of the handle member 50 can be restricted. Accordingly, contact between the handle member 50 and the door panel 210 can be prevented, and the ease of incorporation can be improved.

The door handle device 100 can be appropriately changed as long as the door handle device 100 has a shape in which the movement of the handle member 50 is restricted when the handle member 50 is incorporated and in which the handle member 50 and the door panel 210 do not abut against each other. In the embodiment described above, the step portion 14 which is the rear end portion of the bulging portion 15 restricts the movement of the handle member 50, and the shape of the base member opening 10a of the base member 10 is not limited to the embodiment described above. For example, any one of the edge portion 14a of the step portion 14 inclined with respect to the edge portion 12a of the widened portion 12 and the edge portion 14b of the step portion 14 perpendicularly connected to the edge portion 13a of the narrowed portion 13 may be formed alone. Further, the thickness of the outer wall 11 around the base member opening 10a may be constant, and the bulging portion 15 may not be provided.

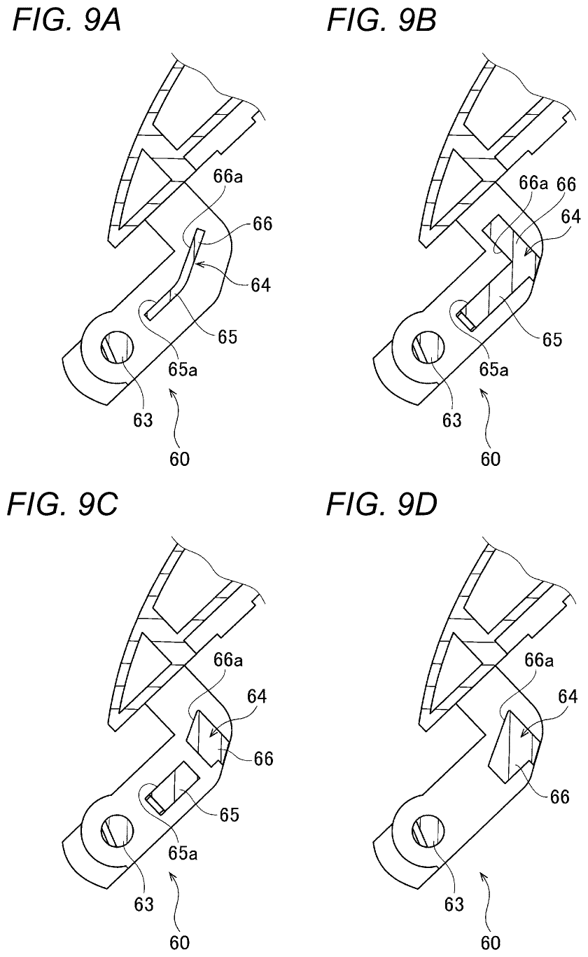

The shape of the restricting protrusion 64 provided on the hinge arm portion 60 is not limited to the shape described above. For example, as shown in FIG. 9A, the shape of the restricting protrusion 64 may be a shape in which the boundary portion between the position restricting surface 65a and the angle restricting surface 66a may be connected to have a curved surface shape, and in which the handle member 50 can be smoothly inserted. The width of the restricting protrusion 64 in the vehicle width direction may be smaller than that in the example shown in FIG. 2 and the like. In the example shown in FIG. 9B, the angle restricting portion 66 is provided perpendicular to the position restricting portion 65, and the position restricting surface 65a and the angle restricting surface 66a are orthogonal to each other. Accordingly, the insertion angle of the handle member 50 can be reliably restricted. As in the examples shown in FIGS. 9C and 9D, a shape in which the position restricting portion 65 and the angle restricting portion 66 are independent of each other or a shape including only the angle restricting portion 66 is also possible.

In these modifications, the restricting protrusion 64 is also formed in an elongated shape having a predetermined length in the longitudinal direction of the hinge arm portion 60. Accordingly, when the hinge arm portion 60 is inserted into the base member opening 10a, the restricting protrusion 64 and the base member opening edge (the step portion 14) defining the base member opening 10a can continuously or intermittently abut against each other, and the movement and the angle of the handle member 50 can be easily restricted. The length of the restricting protrusion 64 in the longitudinal direction of the hinge arm portion 60 in this case is the length from the front end portion (the end portion on the support protrusion 63 side) of the restricting protrusion 64 to the rear end side (the end portion on the side opposite to the support protrusion 63). For example, even when the restricting protrusion 64 is separated into the position restricting portion 65 and the angle restricting portion 66 (the case shown in FIG. 9C), the length of the restricting protrusion 64 in the longitudinal direction of the hinge arm portion 60 is the length from the front end portion of the position restricting portion 65 to the rear end portion of the angle restricting portion 66.

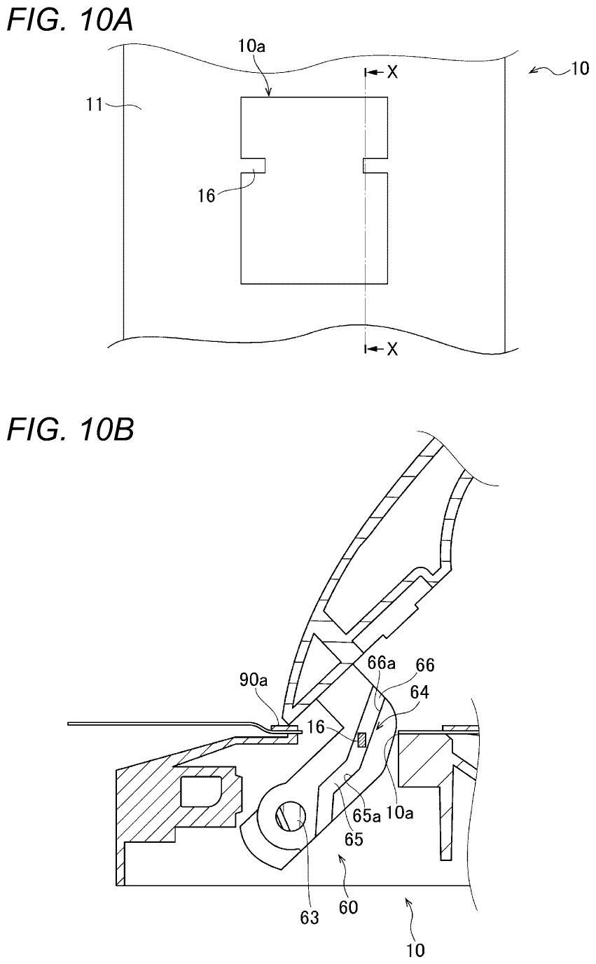

As shown in FIGS. 10A and 10B, a protruding portion 16 may be provided at the base member opening edge defining the base member opening 10a of the base member 10, and the groove-shaped position restricting portion 65 having the position restricting surface 65a on the inner surface and the groove-shaped angle restricting portion 66 having the angle restricting surface 66a on the inner surface may be recessed in the hinge arm portion 60. In this case, the position in the front-rear direction and the insertion angle of the handle member 50 are restricted by the protruding portion 16 passing through the groove-shaped position restricting portion 65 and angle restricting portion 66. In this example, the movement of the handle member 50 in the front-rear direction is reliably restricted.

As the example described above, the movement restricting portion and the base member opening edge abut against each other, so that the movement range of the handle member inside the base member opening can be restricted.

### Another Embodiment

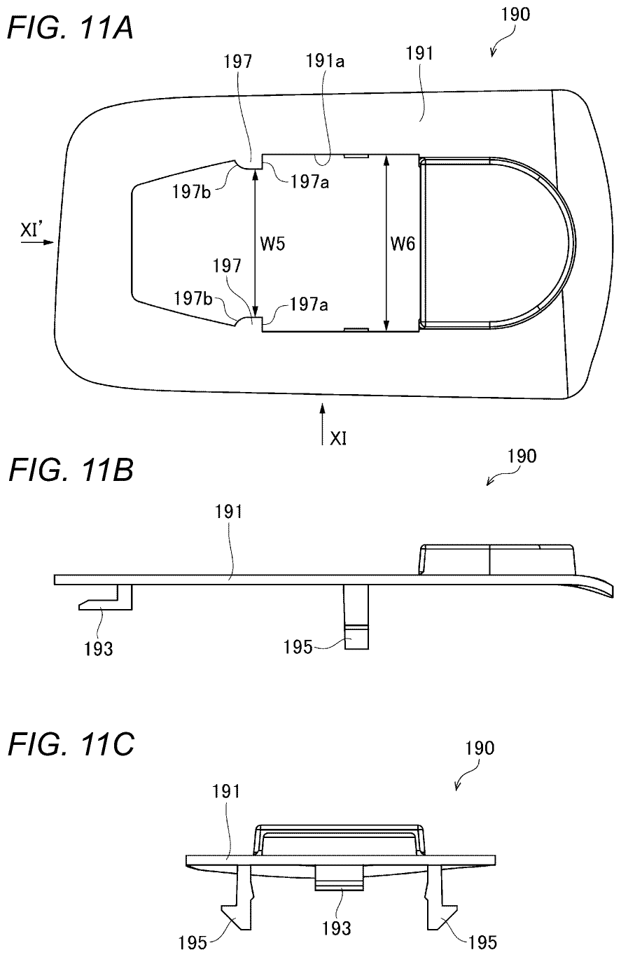

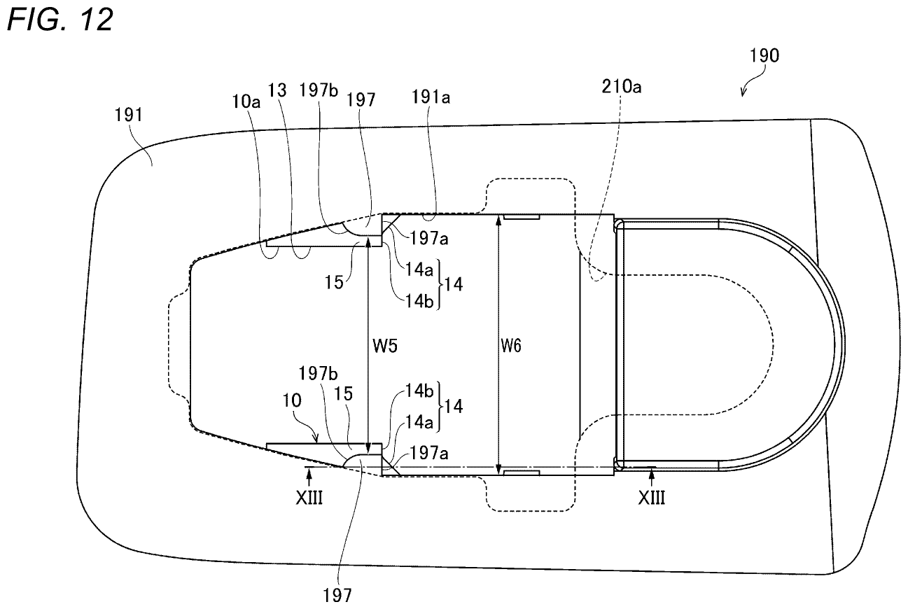

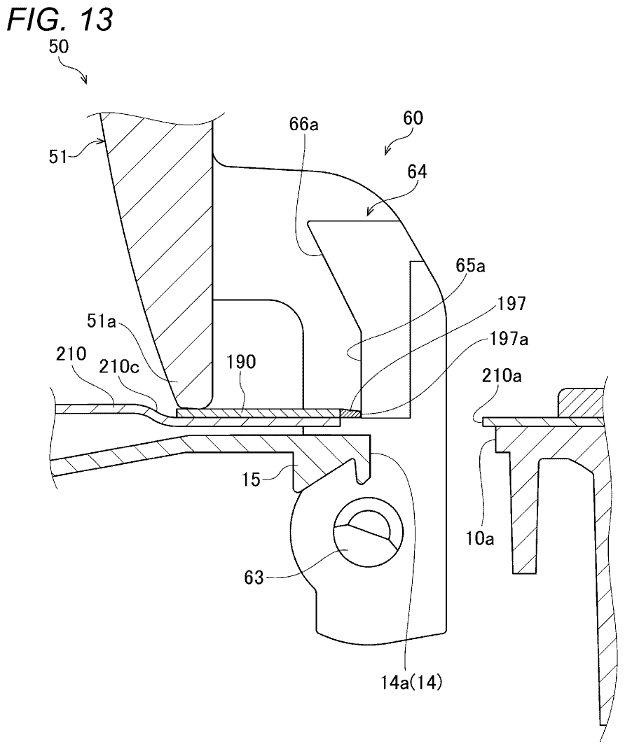

Next, a door handle device according to another embodiment will be described with reference to FIGS. 11 to 13. The same structural portions as those of the embodiment described above are denoted by the same reference signs, and description thereof will be omitted. FIG. 11A is a plan view of a gasket according to another embodiment as viewed from a vehicle outer side. FIG. 11B is a plan view of the gasket according to another embodiment as viewed in a direction of arrow XI in FIG. 11A. FIG. 11C is a plan view of the gasket according to another embodiment as viewed in a direction of arrow XI′ in FIG. 11A. FIG. 12 is a plan view of the gasket provided on the door panel as viewed from a vehicle outer side. FIG. 13 is a cross-sectional view showing an aspect in which the handle member is incorporated into the base member, and corresponds to a position indicated by a line XIII-XIII in FIG. 12. In FIG. 11A, FIG. 12, and FIG. 13, the left side is the front of the vehicle.

In the door handle device according to another embodiment, a gasket 190 provided on the opening edge of the front panel opening 210a is different from the gasket 90a according to the embodiment described above. The gasket 190 according to another embodiment includes a pair of auxiliary restricting portions 197, 197. In the following description of the gasket 190, description will be made based on a state in which the gasket 190 is attached to the vehicle door 200.

As shown in FIGS. 11A to 11C, FIG. 12, and FIG. 13, the gasket 190 according to the present embodiment is formed in an annular shape along the opening edge of the panel opening 210a. In FIG. 12, the opening edge of the panel opening 210a is indicated by a broken line.

The gasket 190 includes: a plate-shaped gasket main body portion 191 in which a gasket opening 191a is formed in a central portion; a front locking claw 193 protruding on a back surface side of the gasket main body portion 191 in front of the gasket opening 191a; a pair of rear locking claws 195, 195 protruding on the back surface side of the gasket main body portion 191 on both upper-lower direction sides of the gasket opening 191a; and a pair of auxiliary restricting portions 197, 197 formed on an opening edge of the gasket opening 191a.

The front locking claw 193 and the pair of rear locking claws 195, 195 each have elasticity. The gasket 190 according to the present embodiment is fixed to the vehicle outer side of the door panel 210 by locking the front locking claw 193 to a front end portion of the opening edges of the panel opening 210a and the base member opening 10a, and locking the rear locking claws 195, 195 to upper-lower direction end portions of the opening edges of the panel opening 210a and the base member opening 10a.

The gasket main body portion 191 is disposed between the main body portion 51 of the handle member 50 and the door panel 210. More specifically, the gasket main body portion 191 is disposed inside a recessed portion 210c (see FIG. 13) recessed toward the vehicle inner side so as to surround the panel opening 210a in the door panel 210.

The gasket opening 191a penetrates the gasket main body portion 191 in a front-back direction at the central portion of the gasket main body portion 191. The gasket opening 191a communicates with the panel opening 210a and the base member opening 10a, and the hinge arm portion 60 is inserted therethrough when the handle member 50 is incorporated into the base member 10.

The pair of auxiliary restricting portions 197, 197 restrict forward movement of the handle member 50 by abutting against the restricting protrusion 64 when the hinge arm portion 60 is inserted. In the present embodiment, the pair of auxiliary restricting portions 197, 197 are made of the same material as the gasket main body portion 191, and are integrally formed with the gasket main body portion 191. The pair of auxiliary restricting portions 197, 197 are protrusions projecting in directions approaching each other from opening edges of the gasket opening 191a opposed to each other in the upper-lower direction.

In the present embodiment, a rear end surface 197a of each auxiliary restricting portion 197 is a flat surface extending in the upper-lower direction and the vehicle width direction (a thickness direction of the gasket 190). A front end surface 197b of each auxiliary restricting portion 197 has an arc shape as viewed in the vehicle width direction.

In the present embodiment, a connection portion of the auxiliary restricting portion 197 to a peripheral edge of the gasket opening 191a has the same thickness as the gasket main body portion 191. A surface of the auxiliary restricting portion 197 (a vehicle outer side surface) is inclined in a direction toward the back surface side (the vehicle inner side) toward the rear side. Accordingly, even when a distal end portion of the restricting protrusion 64 abuts against the vehicle outer side surface of the auxiliary restricting portion 197, the hinge arm portion 60 can be easily guided into the gasket opening 191a behind the auxiliary restricting portion 197.

The auxiliary restricting portion 197 is disposed on the vehicle outer side of the bulging portion 15 of the base member opening 10a. In the present embodiment, the rear end surface 197a of the auxiliary restricting portion 197 is located at the same position in the front-rear direction as the edge portion 14b of the step portion 14 in the base member opening 10a.

From a viewpoint of restricting forward movement of the handle member 50, the rear end surface 197a of the auxiliary restricting portion 197 is preferably positioned rearward of the edge portion 14b of the step portion 14, and more preferably positioned rearward of the edge portion 14a. The rear end surface 197a may be disposed forward of the step portion 14.

An upper-lower direction width W5 between distal ends of the pair of auxiliary restricting portions 197, 197 is smaller than the upper-lower direction width W3 of the restricting protrusion 64 (in the hinge arm portion 60, the width of the restricting protrusion 64 in a protruding direction at a portion where the restricting protrusion 64 is formed; see FIG. 4B). Further, in the gasket opening 191a, an upper-lower direction width W6 of a portion behind the auxiliary restricting portions 197 is larger than the upper-lower direction width W3 of the restricting protrusion 64.

That is, when the hinge arm portion 60 is inserted into the base member opening 10a, the restricting protrusion 64 of the hinge arm portion 60 cannot pass between the pair of auxiliary restricting portions 197, 197, and can pass through a portion behind the auxiliary restricting portions 197. Accordingly, the position restricting surface 65a of the hinge arm portion 60 abuts against the rear end surface 197a of the auxiliary restricting portion 197 formed on the gasket 190, so that forward movement of the handle member 50 is restricted.

Here, an operator who attaches the handle member may, for example, stand on the vehicle inner side of a vehicle door (hereinafter, also referred to as a door), and lean out through a window frame of the door to attach the handle member. In such a case, it is difficult for the operator to visually recognize a position of an opening of the door (for example, the panel opening 210a or the like), and thus the handle member tends to interfere with the door when the handle member is inserted. In addition, since the door moves along a line in a factory, in a conventional handle member or gasket, the position of the door may shift, as viewed by the operator, during insertion of the handle member, and the handle member and the door may interfere with each other.

Therefore, in the present embodiment, by providing the auxiliary restricting portion 197 on the gasket 190 located on the surface side of the door panel 210, it is possible to improve workability when attaching the handle member 50 and suppress interference of the handle member 50 with the vehicle door 200.

More specifically, in the present embodiment, during an operation of inserting the hinge arm portion 60 into the base member 10, even when the handle member 50 is pushed relatively forward with respect to the vehicle door 200 in a state in which the restricting protrusion 64 is positioned on the vehicle outer side of the base member opening 10a of the base member 10, the auxiliary restricting portion 197 of the gasket 190 can restrict the handle member 50 from moving forward with respect to the vehicle door 200. Accordingly, it is possible to more reliably prevent the distal end portion 51a of the main body portion 51 of the handle member 50 from coming into contact with the door panel 210.

Further, the front end surface 197b of the auxiliary restricting portion 197 has an arc shape as viewed in the vehicle width direction. Accordingly, while securing rigidity of the auxiliary restricting portion 197 against a load in the front-rear direction, the size of the auxiliary restricting portion 197 can be minimized, and the gasket 190 can be reduced in weight.

The outer shape of the gasket 190 and the shape of the gasket opening 191a can be appropriately changed according to shapes of the main body portion 51 and the hinge arm portion 60 of the handle member 50. For example, the auxiliary restricting portion 197 may extend to a front end portion of the gasket opening 191a. Further, in the above example, the pair of auxiliary restricting portions 197, 197 are provided, but only one auxiliary restricting portion 197 may be provided. Even in this case, the rear end surface 197a of the auxiliary restricting portion 197 and the restricting protrusion 64 of the hinge arm portion 60 abut against each other, whereby a position of the handle member 50 in the front-rear direction can be restricted. Furthermore, a direction in which the gasket 190 is attached may be changed according to directions in which the base member 10 and the handle member 50 are attached. When the base member 10 and the handle member 50 are attached in a state reversed in the front-rear direction from the illustrated state, the gasket 190 can also be arranged with front and rear reversed.

As described above, the present specification discloses the following configurations. [1] A door handle device for a vehicle, the door handle device including:
a base member provided on a back surface of a door panel of a vehicle; and
a handle member provided on the base member from a front surface side of the door panel,
in which the base member includes a base member opening edge that defines a base member opening communicating with an opening of the door panel,
in which the handle member includes
   a main body portion formed in an elongated shape and exposed on a front surface of the door panel, and
   a hinge arm portion protruding from one end side of the main body portion in a longitudinal direction, penetrating the opening of the door panel and the base member opening, and rotatably supported on a support portion of the base member, and
in which the hinge arm portion includes an elongated movement restricting portion configured to restrict a movement range of the handle member by abutting against the base member opening edge when the hinge arm portion is inserted into the base member opening.

According to this configuration, it is possible to prevent the handle member from coming into contact with the door panel when the hinge arm portion of the handle member is inserted into the base member opening in order to incorporate the handle member into a vehicle door, and to improve ease of incorporation.
[2] The door handle device for a vehicle according to [1],
in which the movement restricting portion includes an angle restricting portion configured to restrict an insertion angle of the handle member, and the angle restricting portion extends in a direction intersecting a longitudinal direction of the handle member.

According to this configuration, when the hinge arm portion is inserted into the base member opening, it is possible to prevent the handle member from being inclined, and the handle member and the door panel from coming into contact with each other.
[3] The door handle device for a vehicle according to [2],
in which the movement restricting portion includes a position restricting portion configured to restrict movement of the handle member in a longitudinal direction of the base member, and the position restricting portion extends along the longitudinal direction of the handle member.

According to this configuration, when the hinge arm portion is inserted into the base member opening, it is possible to prevent the handle member from moving in the longitudinal direction of the base member, and the handle member and the door panel from coming into contact with each other.
[4] The door handle device for a vehicle according to any one of [1] to [3],
in which the movement restricting portion protrudes from two end surfaces of the hinge arm portion in a rotation axis direction.

According to this configuration, the movement restricting portion and the base member opening edge can abut against each other with a simple structure, and the insertion position and angle of the handle member can be restricted when the hinge arm portion is inserted into the base member opening.
[5] The door handle device for a vehicle according to any one of [1] to [4],
in which the base member opening includes a widened portion that is larger than a width of the movement restricting portion in a protruding direction at a portion of the hinge arm portion where the movement restricting portion is formed, and a narrowed portion that is closer to the support portion than is the widened portion and that is narrower than the width of the movement restricting portion in the protruding direction at the portion of the hinge arm portion where the movement restricting portion is formed, and
in which the base member opening edge that defines the base member opening includes a step portion that connects the narrowed portion and the widened portion and that is capable of abutting against the movement restricting portion.

According to this configuration, the movement restricting portion and the base member opening edge can abut against each other with a simple structure, and the insertion position and angle of the handle member can be restricted when the hinge arm portion is inserted into the base member opening.
[6] The door handle device for a vehicle according to [5],
in which the step portion extends from the base member opening edge in a vehicle width direction.

According to this configuration, the angle restricting portion and the position restricting portion can abut against the base member opening edge with a simple structure, and when the hinge arm portion is inserted into the base member opening, the position and angle of the handle member can be restricted, and the handle member and the door panel can be prevented from coming into contact with each other.
[7] The door handle device for a vehicle according to [4],
in which the position restricting portion and the angle restricting portion are connected such that a boundary portion is bent.

According to this configuration, when the hinge arm portion is inserted into the base member opening, the operator can obtain a click feeling, and the handle member can be rotated at an appropriate timing.
[8] A door handle device for a vehicle, the door handle device including:
a base member provided on a back surface of a door panel of a vehicle; and
a handle member provided on the base member from a front surface side of the door panel,
in which the base member includes a base member opening edge that defines a base member opening communicating with an opening of the door panel,
in which the handle member includes
   a main body portion formed in an elongated shape and exposed on a front surface of the door panel, and
   a hinge arm portion protruding from one end side of the main body portion in a longitudinal direction, penetrating the opening of the door panel and the base member opening, and rotatably supported on a support portion of the base member, and
in which the hinge arm portion includes an elongated movement restricting portion that abuts against the base member opening edge when the hinge arm portion is inserted into the base member opening.

According to this configuration, it is possible to prevent the handle member from coming into contact with the door panel when the hinge arm portion of the handle member is inserted into the base member opening in order to incorporate the handle member into a vehicle door, and to improve ease of incorporation.
[9] The door handle device for a vehicle according to any one of [1] to [8], further including:
a gasket having a gasket opening communicating with the opening of the door panel and disposed between the door panel and the main body portion of the handle member,
in which an opening edge of the gasket opening is formed with an auxiliary restricting portion that narrows the gasket opening to be smaller than a width of the movement restricting portion in a protruding direction at a portion of the hinge arm portion where the movement restricting portion is formed, and that is capable of abutting against the movement restricting portion.

According to this configuration, even when insertion of the hinge arm portion is relatively shallow, forward movement of the handle member can be restricted by the auxiliary restricting portion. Accordingly, it is possible to more reliably prevent the handle member from coming into contact with the door panel.
[10] The door handle device for a vehicle according to [9],
in which the auxiliary restricting portion is a pair of protrusions protruding from the opening edge of the gasket opening in directions approaching each other.

According to this configuration, while securing rigidity of the auxiliary restricting portion against a load in the front-rear direction, the size of the auxiliary restricting portion can be minimized, and the gasket can be reduced in weight.

What is claimed is:

1. A door handle device for a vehicle, the door handle device comprising:
a base member provided on a back surface of a door panel of a vehicle; and
a handle member provided on the base member from a front surface side of the door panel,
wherein the base member includes a base member opening edge that defines a base member opening communicating with an opening of the door panel,
wherein the handle member includes:
a main body portion formed in an elongated shape and exposed on a front surface of the door panel; and
a hinge arm portion protruding from one end side of the main body portion in a longitudinal direction, penetrating the opening of the door panel and the base member opening, and rotatably supported on a support portion of the base member, and
wherein the hinge arm portion includes an elongated movement restricting portion configured to restrict a movement range of the handle member by abutting against the base member opening edge when the hinge arm portion is inserted into the base member opening.

2. The door handle device for a vehicle according to claim 1,
wherein the movement restricting portion includes an angle restricting portion configured to restrict an insertion angle of the handle member, and the angle restricting portion extends in a direction intersecting a longitudinal direction of the handle member.

3. The door handle device for a vehicle according to claim 2,
wherein the movement restricting portion includes a position restricting portion configured to restrict movement of the handle member in a longitudinal direction of the base member, and the position restricting portion extends along the longitudinal direction of the handle member.

4. The door handle device for a vehicle according to claim 1,
wherein the movement restricting portion protrudes from two end surfaces of the hinge arm portion in a rotation axis direction.

5. The door handle device for a vehicle according to claim 4,
wherein the base member opening includes a widened portion that is larger than a width of the movement restricting portion in a protruding direction at a portion of the hinge arm portion where the movement restricting portion is formed, and a narrowed portion that is closer to the support portion than is the widened portion and that is narrower than the width of the movement restricting portion in the protruding direction at the portion of the hinge arm portion where the movement restricting portion is formed, and
wherein the base member opening edge that defines the base member opening includes a step portion that connects the narrowed portion and the widened portion and that is capable of abutting against the movement restricting portion.

6. The door handle device for a vehicle according to claim 5,
wherein the step portion extends from the base member opening edge in a vehicle width direction.

7. The door handle device for a vehicle according to claim 3,
wherein the position restricting portion and the angle restricting portion are connected such that a boundary portion is bent.

8. A door handle device for a vehicle, the door handle device comprising:
a base member provided on a back surface of a door panel of a vehicle; and
a handle member provided on the base member from a front surface side of the door panel,
wherein the base member includes a base member opening edge that defines a base member opening communicating with an opening of the door panel,
wherein the handle member includes:
a main body portion formed in an elongated shape and exposed on a front surface of the door panel; and
a hinge arm portion protruding from one end side of the main body portion in a longitudinal direction, penetrating the opening of the door panel and the base member opening, and rotatably supported on a support portion of the base member, and
wherein the hinge arm portion includes an elongated movement restricting portion that abuts against the base member opening edge when the hinge arm portion is inserted into the base member opening.

9. The door handle device for a vehicle according to claim 1, further including:
a gasket having a gasket opening communicating with the opening of the door panel and disposed between the door panel and the main body portion of the handle member,
wherein an opening edge of the gasket opening is formed with an auxiliary restricting portion that narrows the gasket opening to be smaller than a width of the movement restricting portion in a protruding direction at a portion of the hinge arm portion where the movement restricting portion is formed, and that is capable of abutting against the movement restricting portion.

10. The door handle device for a vehicle according to claim 9,
wherein the auxiliary restricting portion is a pair of protrusions protruding from the opening edge of the gasket opening in directions approaching each other.
